(19) United States
(12) Patent Application Publication
(10) Pub. No.: US 2006/0289105 A1
(43) Pub. Date: Dec. 28, 2006

(54) Method for the manufacture of wood material boards in a pressing apparatus, and circulation apparatus for transport screens for the practice of the method

(75) Inventor: Gernot von Haas, Leimen (DE)

Correspondence Address: FOLEY AND LARDNER LLP;SUITE 500, 3000 K STREET NW, WASHINGTON, DC, 20007, US

(73) Assignee: Dieffenbacher GmbH + Co. KG

(21) Appl. No.: 11/405,013

(22) Filed: Apr. 17, 2006

(30) Foreign Application Priority Data
Apr. 17, 2005 (DE) 102005 017 778.6

(51) Int. Cl. B65G 47/64; B27N 3/00

(52) U.S. Cl. 156/62.2

(57) ABSTRACT

Method and apparatus for the production of wood material boards, such as chip boards or fiber boards, in a pressing apparatus with a single or multiple stage press and circulating carrier screens, with a loading basket for the carrier screens covered with mats of the material to be pressed, and an unloading basket for the carrier screens bearing the finished wood material boards, characterized in that the carrier screens are fed from the unloading basket in twos or more, the stripping devices separate the wood material boards alternately from the carrier screens, the carrier screens are brought back on separate conveyor lines to the screen entrance, and the carrier screens are introduced back into the screen entrance at one or more places.

### BACKGROUND OF THE INVENTION

The invention relates to a method for the manufacture of boards of wood material, such as chip boards or fiber boards, in a pressing apparatus with an single-stage or multi-stage press, and a circulating system for carrier screens for the practice of the method.

The invention thus relates to an apparatus for the manufacture of wood material boards, with a pressing apparatus and carrier screens passing through it, a screen entrance for carrier screens bearing mats of outspread material and a screen return for empty carrier screens, the screen entrance and the screen return forming conveyor lines of carrier belts. The screens can be passed over to the screen entrance directly in front of the spreading machine. But they can also be passed to the screen entrance as a combination line after the forming belt. The forward speed of the screen entrance (also called the main chain conveyor) is the same as the speed of the forming belt.

Apparatus of this kind for the manufacture of wood materials have been disclosed in DE 101 22 969, for example. This apparatus is a conveyor for carrying screens bearing mats of outspread material in the course of the manufacture of boards of wood material, and having a screen entrance and a screen return. Such carrier screens consist as a rule of woven metal screens on the head end of which a head bar or towing bar is provided. The head bar consists of lateral drivers and a center catch. The length of the carrier screen amounts to between 1 and 15 m. One often used carrier screen length is 7.6 m; its length is the result of a fact that the board length is very well suited for structural applications and the board produced can easily be divided into smaller pieces with a length of 2.4 m. The carrier screens are returned beneath the press after separation from the board, and either—as mentioned above—brought in front of a spreading station or to a main chain conveyor (screen entrance) in which the wood material mat is transferred from a forming belt to the screen.

In the state of the art, such board apparatus consist of an unloading basket and usually two trains, lying one on the other, of chains and belt conveyors which carry the screens with the boards lying on them out of the unloading basket to a stripping system. In front of the stripping conveyor a tipple belt is arranged which combines the two trains into one transport belt. After the stripping conveyor, which is also configured as a chain conveyor, the carrier screens are transported back to the screen entrance. For this they have to travel a great distance and possibly have a higher rate of feed than the forming belt.

Besides, there is a chief problem in such transport systems, consisting in the speed of movement of the carrier screens and thus the capacity of the apparatus. In the case of a carrier screen length of 7.5 m, after the press the speed of the carrier screen in the removal of the screen from the wood material board by a stripping conveyor is limited to 2000 mm/s. If the entrance is increased to more than 3000 mm/s, it can happen that the drivers of the stripping apparatus no longer reliably detect the drivers of the towing bar and the carrier screens are not severed. The entrance on the conveyor lines in the screen return conveyor under the press with belt conveyors is also limited to 3 m/s. In case of a higher entrance rate the head bars can jump over one another.

The speed of the carrier screen after the press is not equal to the speed of the forming belt ahead of the screen entrance, since when the unloading basket is unloaded a certain dead time occurs, since the travel from level to level takes a few seconds. A fast unloading of the unloading basket, and thus also a fast unloading of the press, requires a correspondingly fast removal of the carrier screens, which as a rule are held in the screen return on the belt conveyors of the transport lines. In the state of the art, quick removal is hardly possible due to the limited feed speed of the conveyors. Furthermore, the holding capacity in a return run is limited.

### SUMMARY OF THE INVENTION

The problem which the invention addresses is to provide a method whereby the forming belt speed can be increased and thus also the speed of production for the same reliability of production, and an apparatus for circulating carrier screens for the practice of this method.

The solution for the method consists, according to one preferred embodiment, in that the carrier screens are carried from the discharge basket to two or more stripping apparatus, the stripping apparatus alternately separate the wood material boards from the carrier screens, the carrier screens are brought back onto separate conveyor lines and the carrier screens are introduced at one or more places back into the screen entrance.

The solution, for a circulating apparatus for the practice of the method of the invention, consists in the fact that the circulating apparatus consists of two or more stripping systems, two or more transport lines and one or more apparatus for delivery to the screen entrance.

Due to the use of two stripping apparatus, each stripping apparatus can be operated at the maximum feed speed without the need to deal with difficulties in the transport of the carrier screens. Due to the multiple returning and bringing together, the spreading can be done at a rate corresponding to the multiplied speed, or the forming belt can deposit the mats onto the carrier screens at a correspondingly increased rate. On account of the off bearing of every n-th wood material board that takes place laterally in alternation between two or more stripping systems it is not absolutely necessary to run the final production line at a greatly increased speed. Also the trimming and cutting to shape are subject to certain speed limits in production and would here only lead to further problems. Instead, the rate of the feed of the boards in the final production is again reduced with respect to the forming belt, since two or more final production lines can be provided. The redundancy of the production line thus created in the final production area is also advantageous. An additional advantage of the invention is that the holding capacity of the carrier screens when the press is running unloaded is increased accordingly by the two or more conveyor belts in the return.

The delivery of the carrier screens to the screen entrance can be performed in two different ways. For one thing, the carrier screens can be transferred at two points by two feeding apparatus, in the form for example of chain conveyors. The carrier screens are in that case already accelerated on the feeding system to the speed of the forming belt. The screens are transferred to the feeding apparatus as a rule from the conveyor line, which can be in the form of a belt conveyor. The transfer of the carrier screens by means of two feeding systems makes the forming belt speed increase possible, since in the state of the art the transfer of the screens with only one return and only one transfer point assumes a very precise time coordination of the drives, and was often the reason for a limit on the forming belt speed.

As an alternative, instead of two feed systems only one can be arranged, while the two returning conveyor lines feed directly to this one feeding system. Thus the carrier screens are transferred to the screen entrance at only one point.

Additional advantageous measures and configurations of the subject of the invention will appear in the claims and in the following description of the drawings. Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF DESCRIPTION OF THE DRAWINGS

The accompanying drawings, which are incorporated in and constitute a part of the specification, illustrate presently preferred exemplary embodiments of the invention, and, together with the general description given above and the detailed description of the preferred embodiments given below, serve to explain the principles of the invention.

FIG. 1 A side view of a very schematically represented pressing apparatus for the manufacture of wood material boards.

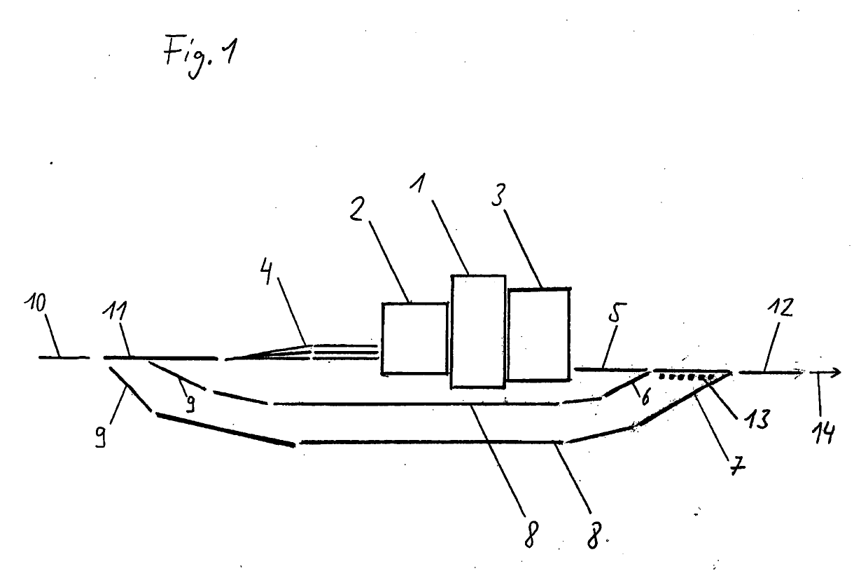

FIG. 2 A top plan view of a schematically represented pressing apparatus of FIG. 1.

FIG. 3 An enlarged side view of the carrier screen entrance according to FIG. 1, and

FIG. 4 A variant of the carrier screen delivery to the screen entrance.

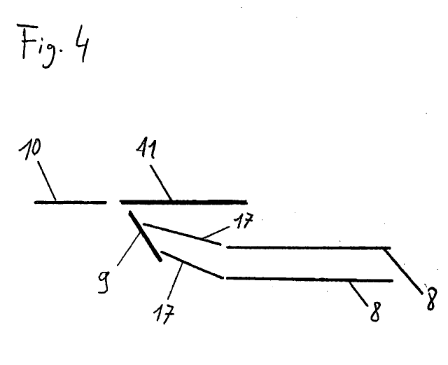

### DETAILED DESCRIPTION OF THE PREFERRED EMBODIMENTS

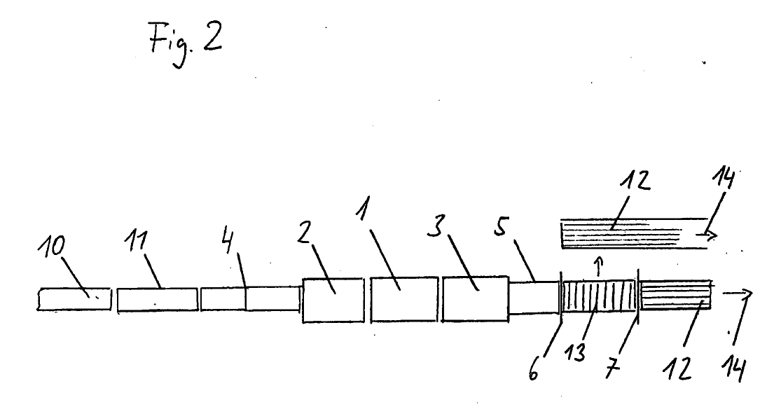

A press apparatus for the manufacture of wood material boards is represented in the figures, with the corresponding apparatus for the circulation of carrier screens. For the manufacture of wood material boards, a mat (not shown) of material for pressing is spread onto a forming belt 10. This forming bent 10 then transfers the mat of material onto carrier screens 15 which are carried in the screen entrance 11 to the loading system 4. The loading system 4 in turn feeds the carrier screens 15, loaded with the material, into the charging basket 2. When the press 1 opens, the charging basket 2 feeds the carrier screen 15 into the press 1 after the unloading basket 3 has removed the finish-pressed boards 12 with the carrier screen 15 out of the press 1. While the press 1 is closing the unloading basket 3 can be emptied and the charging basket 2 can be refilled. In order to perform the emptying as fast as possible, the carrier screens 15 with the boards 12 are removed from the unloading basket 3 with an unloading conveyor 5. In order to perform the separation of the carrier screen 15 and the board 12 as quickly and gently as possible, either two unloading conveyors 5 can be arranged one above the other and carried separately to one or the other of the stripping devices 6 or 7, or only one unloading conveyor 5 is running, the carrier screen 15 feeds it through two stripping devices 6 and 7 in succession, while in this case the carrier screens are delivered through the stripping devices 6 and 7, down to the conveyor lines 8, and the boards 12 are shifted transversely in alternation either by a cross conveyor 13 or further along to production lines of the after-treatment system 14. As shown in FIG. 2, after the transverse displacement by the cross conveyor 13, another turn can be made in order to follow the production rooms that run, as a rule, lengthwise.

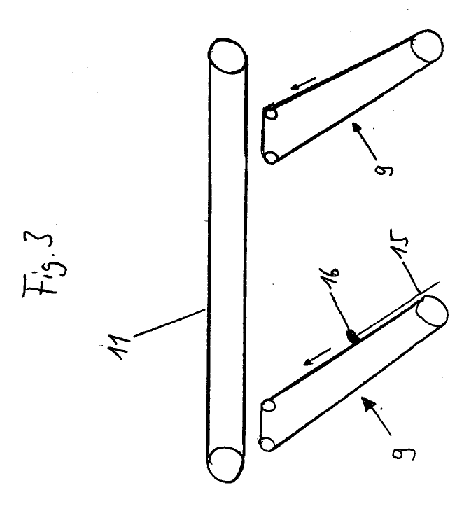

The conveyor lines 8 lead the carrier screens underneath the press 1, back toward the forming belt 10 or screen entrance 11. It is not necessary to load the carrier screen 15 with a forming belt 10. Instead, it may also be possible to load the carrier screen 15 with the material directly in the screen entrance 11. In the example represented, the conveyor lines 8 transfer the carrier screens 15 to the feeding apparatus 9, which pass the carrier screens 15 successively to the screen entrance 11 from below. As shown for example in FIG. 3, the feeding apparatus consist as a rule of chain conveyors with drivers 16 which can engage the carrier screen 15 at appropriate points. In an alternative embodiment the carrier screens 15 can also pass first onto an intermediate conveyor 17 which then transfers the carrier screen 15 to a feeding apparatus 9. Thus it is possible to load the screen entrance with only one feeding apparatus 9. The intermediate conveyor 17 is necessary because the conveyor lines are constructed as a rule only as belt conveyors and do not have any drivers 16. If the conveyor lines nevertheless are to be enabled for precision delivery, they can of course feed directly to a feeding apparatus without intermediate transportation. At each of the points which require precise delivery of the carrier screens, chain conveyors are in the apparatus, such as in the unloading conveyor 5, in the screen entrance 11, in the stripping system 6 and 7, and in the feeding apparatus 9.

When the carrier screens 15 are unloaded from the unloading basket 3 into the stripping system 6 and 7, chain conveyors can be provided on the conveyor belts with the towing bars and then belt conveyors, and the stripping conveyors 6 and 7 can also consist of a chain with drivers and engage a towing bar on the carrier screen. Just before the mat of material is transferred to the carrier screen a cleaning station can be arranged in the screen entrance for the carrier screens.

The priority document, German patent application DE 102005 017 778.6 filed Apr. 17, 2005, is hereby incorporated by reference in its entirety.

Additional advantages and modifications will readily occur to those skilled in the art. Therefore, the invention in its broader aspects is not limited to the specific details, and representative devices and steps, shown and described herein. Accordingly, various modifications may be made without departing from the spirit and scope of the general inventive concept as defined by the appended claims and their equivalents.

What is claimed is:

1. Method for the production of wood material boards, such as chip boards or fiber boards, in a pressing apparatus with a single or multiple stage press and circulating carrier screens, with a loading basket for the carrier screens covered with mats of the material to be pressed, and an unloading basket for the carrier screens bearing the finished wood material boards, comprising:
feeding the carrier screens from the unloading basket in twos or more;
using stripping devices to separate the wood material boards alternately from the carrier screens;
bringing the carrier screens back on separate conveyor lines to a screen entrance; and
introducing the carrier screens back into the screen entrance at one or more places.

2. Circulating apparatus for carrier screens, for the practice of the method of claim 1, comprising two or more stripping devices, two or more conveyor lines and one or more feeding apparatus for carrying screens to the screen entrance.

3. Circulating apparatus for carrier screens according to claim 2, wherein the material boards, after separation are carried from the separating system by the carrier screens on different conveyor lines for further processing.

4. Circulating apparatus for carrier screens according to claim 2, wherein the conveyor lines for the carrier screens after separation of carrier screen and board are arranged beneath the press.

5. Circulating apparatus for carrier screens according to claim 2, wherein for unloading the carrier screens from the unloading basket to the separating conveyors chain conveyors are disposed above towing bars of the conveyor belts and then belt conveyors are disposed.

6. Circulating apparatus for carrier screens according to claim 2, wherein separating conveyors comprise a chain with drivers and engage the carrier screen at a towing bar.

7. Circulating apparatus for carrier screens according to claim 2, wherein, shortly before the transfer of the mats to the carrier screen, a cleaning station is arranged in the screen entrance for the carrier screens.
